(19) United States
(12) Patent Application Publication
(10) Pub. No.: US 2007/0098222 A1
(43) Pub. Date: May 3, 2007

(54) SCENE ANALYSIS

(75) Inventors: Robert Mark Stefan Porter, Winchester (GB); Ratna Beresford, Basingstoke (GB); Simon Dominic Haynes, Fleet (GB)

Correspondence Address: OBLON, SPIVAK, MCCLELLAND, MAIER & NEUSTADT, P.C., 1940 DUKE STREET, ALEXANDRIA, VA, 22314, US

(73) Assignee: SONY UNITED KINGDOM LIMITED, Weybridge (GB)

(21) Appl. No.: 11/552,278

(22) Filed: Oct. 24, 2006

(30) Foreign Application Priority Data
Oct. 31, 2005 (GB) 0522182.5

(51) Int. Cl. G06K 9/00; G06K 9/48

(52) U.S. Cl. 382/103; 382/199

(57) ABSTRACT

Apparatus is arranged in operation to perform a method of estimating the number of individuals in a scene. The method comprises generating, for a plurality of image positions within at least a portion of a captured image of the scene, an edge correspondence value indicative of positional and angular correspondence with a representation of at least a partial outline of an individual. Analysis of the edge correspondence value is used to detect whether each of the plurality of image positions contributes to at least part of an image of an individual.

### BACKGROUND OF THE INVENTION

1. Field of the Invention

This invention relates to apparatus, methods, processor control code and signals for the analysis of image data representing a scene.

2. Description of the Prior Art

In many situations where populations of individuals move and/or congregate within a space, it is desirable to automatically monitor the population size, and/or whether the population is growing or shrinking, flowing freely or becoming congested. This may be true, for example, of crowds of people at a station, airport or amusement park, or of bottles in a factory being channelled into a filling mechanism, or of livestock being transferred at a market.

Such information allows appropriate responses to be made; for example, if a production line shows signs of congestion at a key point, then either preceding steps in the line can be temporarily slowed down, or subsequent steps can be temporarily sped up to alleviate the situation. Similarly, if a platform on a train station is crowded, entrance gates could be closed to limit the danger of passengers being forced too close to the platform edge by additional people joining the platform.

In each case, the ability to assess the state of the population requires the ability to estimate the number of individuals present, and/or a change in that number. This in turn requires the ability to detect their presence, potentially in a tight crowd.

Thus there are a number of requirements for detection:
i. an individual may be mobile or stationary;
ii. it is likely that individuals will overlap in the scene, and;
iii. it is desirable to discount other elements of the scene.

Several detection and tracking methods for individuals exist in the literature, and are predominantly oriented toward detecting humans, typically for purposes of security or intelligent bandwidth compression in video applications. The methods form a spectrum between pure ‘tracking’ and pure ‘detection’.

Methods related primarily to tracking include particle filtering and image skeletonisation:

Particle filtering entails determining the probability density function of a previously detected individual's state by tracking the state descriptions of candidate particles selected from within the individual's image (for example, see “A tutorial on particle filters for online non-linear/non-Gaussian Bayesian tracking”, M. S. Arulampalam, S. Maskell, N. Gordon and T. Clapp, IEEE Trans. Signal Processing, vol. 50, no. 2, Feb. 2002, pp. 174-188). A particle state may typically comprise its position, velocity and acceleration. It is particularly robust as it enjoys a high level of redundancy, and can ignore temporarily inconsistent states of some particles at any given moment.

However, it does not provide any means for detecting the individual in the first place.

Image skeletonisation provides a hybrid tracking/detection method, relying on the characteristics of human locomotion to identify people in a scene. The method identifies a moving object by background comparison, and then determines the positions of the extremities of the object in accordance with a skeleton model (for example, a five-pointed asterisk, representing a head, two hands and two feet). The method then compares the successive motion of this skeleton model as it is matched to the object, to determine if the motion is characteristic of a human (by contrast, a car will typically have a static skeletal model despite being in motion).

Whilst this method is robust for individuals walking through a scene, it is unclear that the skeleton model is applicable when a proportion of the extremities of an individual are obscured, or are overlapped by another individual moving in another direction. In addition, for intrinsically inanimate individuals such as bottles in a production line, the skeletal model is inappropriate. More significantly, the method relies on all the individuals being in constant motion relative to the background. This is unrealistic for many crowd scenes.

Methods directed generally toward detection include pseudo-2D hidden Markov models, support vector machine analysis, and edge matching.

A pseudo-2D hidden Markov model (P2DHMM) can in principle be trained to recognise the geometry of a human body. This is achieved by training the P2DHMM on pixel sequences representing images of people, so that it learns typical states and state-transitions of pixels that would allow the model itself to most likely generate people-like pixel sequences in turn. The P2DHMM then performs recognition by assessing the probability that it itself could have generated the observed image selected from the scene, with the probability being highest when the observed image depicts a person.

“Person tracking in real-world scenarios using statistical methods”, G. Rigoll, S. Eickeler and S. Mueller, in IEEE Int. Conference on Automatic Face and Gesture Recognition, Grenoble, France, March 2000, pp. 342-347, discloses such a method, in which a motion model is coupled with an P2DHMM to track an individual using a Kalman filter.

However, investigations suggest that whilst the P2DHMM method is extremely robust in recognising an individual, the generalisation underlying this robustness is disadvantageous when detecting individuals in a crowd, because its region of response surrounding a human is large. This makes it difficult to distinguish neighbouring and overlapping individuals in an image.

Support vector machine (SVM) analysis provides an alternative method of detection by categorising all inputs into two classes, for example ‘human’ and ‘not human’. This is achieved by determining a plane of separation within a multidimensional input space, typically by iteratively moving the plane so as to reduce the classification error to a (preferably global) minimum. This process requires supervision and the presentation of a large number of examples of each class.

For example, “Trainable pedestrian detection”, by C. Papageorgiou and T. Poggio, in Proceedings of International Conference on Image Processing, Kobe, Japan, October 1999, discloses the derivation of a multi-scale wavelet SVM input vector that generates a 1,326 dimensional feature space in which to locate the separation plane. Training used 1,800 example images of people. The system performed well in identifying a plurality of distinct and non-overlapping individuals in a scene, but required considerable computational resources during both training and detection.

In addition to computational load, however, a fundamental problem with categorising the classes ‘human’ and ‘not-human’ using SVMs is the difficulty in adequately defining the second ‘not-human’ class, and therefore the difficulty in optimising the separation plane. This can result in a large number of false-positive responses. Whilst it may be possible to discriminate against these by other methods when detecting or tracking only a few individuals, they cannot so easily be checked for in a crowded scene, as the correct number of individuals present is not known.

Moreover, in a crowded scene where individuals are likely to overlap, the category of ‘human’ must further encompass ‘part-human’, making the correct plane of separation from ‘not human’ more critical still.

This places a significant burden upon the quality and preparation of training examples, and the ability to extract features from the scene that are capable of discriminating part-human features from non-human features. Whilst in principle this is possible, it is not a trivial task and would be likely to require considerable computing power, as well as training investment, for each scenario being evaluated.

Numerous techniques exist for tracing edges in images, most notably the Sobel, Roberts Cross and Canny edge detection techniques, for example, see E. Davies, Machine Vision: Theory, Algorithms and Practicalities, Academic Press, 1990, Chapter. 5., and J. F. Canny: A computational approach to edge detection. IEEE Trans. Pattern Analysis and Machine Intelligence, 8 (6), 1986, 679-698.

Given the ability to detect edges, edge matching can then be used to identify an object by comparing edges with one or more templates representing average target objects or configurations of an object. Consequently it can be used to detect individuals. “Real-time object detection for ‘smart’ vehicles”, by D. M. Gavrila and V. Philomin in Proceedings of IEEE International Conference on Computer Vision, 1999, pp. 87-93, discloses such a system for vehicles, to identify pedestrians and traffic signs. Because the exact overlap of an observed image edge and a target edge may be small or fragmentary, matching is based on the overall distance between points in both edges, with a minimum overall distance occurring when the template edge both resembles and is substantially collocated with the image edge. A candidate image edge is classified according to which template it matches best (within a hierarchy of generalised templates), or is discounted if it fails to achieve a minimum threshold match.

However, this document goes on to note that due to the variability of humans in a scene, over 5,000 automatically generated templates were necessary to achieve a reasonable recognition rate. This number could be expected to increase further if templates for overlapping human shapes were also included to accommodate images of crowd scenes.

Consequently, it is desirable (and an object of the invention) to find an improved means and method by which to evaluate a population in an image.

### SUMMARY OF THE INVENTION

The present invention seeks to address, mitigate or alleviate the above problem.

This invention provides a method of estimating the number of individuals in an image, the method comprising the steps of:

generating, for a plurality of image positions within at least a portion of a captured image of the scene, an edge correspondence value indicative of positional and angular correspondence with a template representation of at least a partial outline of an individual, and;

detecting whether image content at each of the image positions corresponds to at least a part of an image of an individual in response to the detected the edge correspondence value. the

By defining whether an image position contributes to the image of an individual on the basis of positional and angular correspondence with at least a partial outline, a robust estimation of the number of individuals in a scene can be made whether individuals are mobile, stationary, or overlap each other.

This invention also provides a data processing apparatus, arranged in operation to estimate the number of individuals in a scene, the apparatus comprising;

analysis means operable to generate, for a plurality of image positions within at least a portion of a captured image of the scene, an edge correspondence value indicative of positional and angular correspondence with a template representation of at least a partial outline of an individual, and

means operable to detect whether image content at each of the image positions corresponds to at least a part of an image of an individual in response to the detected edge correspondence value.

An apparatus so arranged can thus provide means (for example) to alert a user to overcrowding or congestion, or activate a response such as closing a gate or altering production line speeds.

Various other respective aspects and features of the invention are defined in the appended claims. Features from the dependent claims may be combined with features of the independent claims as appropriate and not merely as explicitly set out in the claims.

### BRIEF DESCRIPTION OF THE DRAWINGS

The above and other objects, features and advantages of the invention will be apparent from the following detailed description of illustrative embodiments which is to be read in connection with the accompanying drawings, in which:

FIG. 1 is a schematic flow diagram illustrating a method of scene analysis in accordance with an embodiment of the present invention;

FIG. 2 is a schematic flow diagram illustrating a method of horizontal and vertical edge analysis in accordance with an embodiment of the present invention;

FIG. 3A is a schematic flow diagram illustrating a method of edge magnitude analysis in accordance with an embodiment of the present invention;

FIG. 3B is a schematic flow diagram illustrating a method of vertical edge analysis in accordance with an embodiment of the present invention;

FIG. 4A is a schematic illustration of vertical and horizontal archetypal masks in accordance with an embodiment of the present invention;

FIG. 4B is a schematic flow diagram illustrating a method of edge mask matching in accordance with an embodiment of the present invention;

FIG. 5A is a schematic flow diagram illustrating a method of edge angle analysis in accordance with an embodiment of the present invention;

FIG. 5B is a schematic flow diagram illustrating a method of moving edge enhancement in accordance with an embodiment of the present invention;

FIG. 6 is a schematic block diagram illustrating a data processing apparatus in accordance with an embodiment of the present invention; and

FIG. 7 is a schematic block diagram illustrating a video processor in accordance with an embodiment of the present invention.

### DESCRIPTION OF THE PREFERRED EMBODIMENTS

A method of estimating the number of individuals in a scene and apparatus operable to carry out such estimation is disclosed. In the following description, a number of specific details are presented in order to provide a thorough understanding of embodiments of the present invention. It will be apparent, however, to a person skilled in the art that these specific details need not be employed to practice the present invention.

In an embodiment of the present invention, a method of estimating the number of individuals in a scene exploits the fact that an image of the scene will typically be captured by a CCTV system mounted comparatively high in the space under surveillance. Thus whilst, for example, the bodies of people may be partially obscured in a crowd, in general their heads will not be obscured. The same would apply for livestock, or for bottle tops (or some other consistent feature of an individual) in a factory line. Consequently and in general, the method determines the presence of individuals by the detection of a selected feature of the individuals that is most consistently visible irrespective of their number.

Without loss of generalisation, and for the purposes of clarity, the method will be described below in relation to the detection of human individuals.

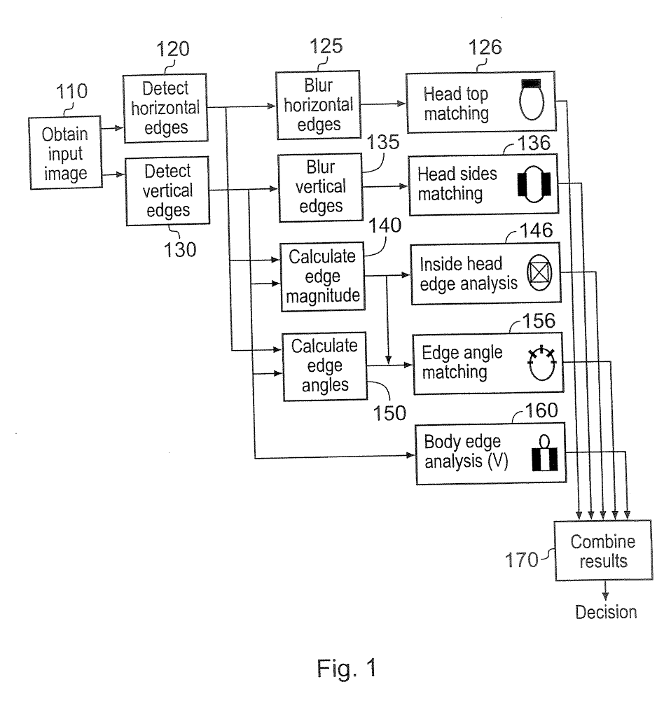

Referring to FIGS. 1, 2 and 3A, in an embodiment of the present invention, a method of estimating the number of individuals in a captured image representing a scene comprises obtaining an input image at step 110, and applying to it or a part thereof a scalar gradient operator such as a Sobel or Roberts Cross operator, to detect horizontal edges at step 120 and vertical edges at step 130 within the image.

Application of the Sobel operator, for example, comprises convolving the input image with the operators

$$[ \begin{matrix}- 1 & - 2 & - 1 \\ 0 & 0 & 0 \\ 1 & 2 & 1\end{matrix} ] and [ \begin{matrix}- 1 & 0 & 1 \\ - 2 & 0 & 2 \\ - 1 & 0 & 1\end{matrix} ]$$

for horizontal and vertical edges respectively. The output may then take the form of a horizontal edge map, or H-map, 220 and a vertical edge map, or V-map, 230 corresponding to the original input image, or that part operated upon. An edge magnitude map 240 may then also be derived from the root sum of squares of the H- and V-maps at step 140, and roughly resembles an outline drawing of the input image.

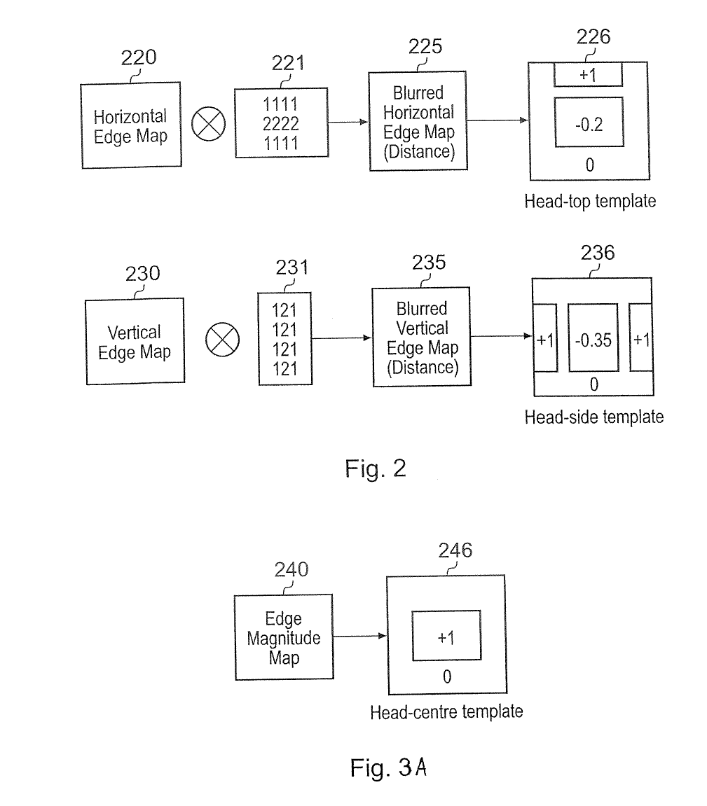

In FIG. 2, in an embodiment of the present invention, the H-map 220 is further processed by convolution with a horizontal blurring filter operator 221 at step 125 in FIG. 1. The result is that each horizontal edge is blurred such that the value at a point on the map diminishes with vertical distance from the original position of an edge, up to a distance determined by the size of the blurring filter 221. Thus the selected size of the blurring filter determines a vertical tolerance level when the blurred H-map 225 is then correlated with an edge template 226 for the top of the head at each position on the map.

The correlation with the head-top edge template ‘scores’ positively for horizontal edges near the top of the template space, which represents a head area, and scores negatively in a region central to the head area. Typical values may be +1 and −0.2 respectively. Edges elsewhere in the template are not scored. A head-top is defined to be present at a given position if the overall score there exceeds a given head-top score threshold.

Similarly, the V-map 230 is further processed by convolution with a vertical blurring filter operator 231 at step 135 in FIG. 1. The result is that each vertical edge is blurred such that the value at a point on the map diminishes with horizontal distance from the original edge position. The distance is a function of the size of the blurring filter selected, and determines a horizontal tolerance level when the blurred V-map 235 is then correlated with an edge template 236 for the sides of the head at each position on the map.

The correlation with the head-sides edge template ‘scores’ positively for vertical edges near either side of the template space, which represents a head area, and scores negatively in a region central to the head area. Typical values are +1 and −0.35 respectively. Edges elsewhere in the template space are not scored. Head-sides are defined to be present at a given position if the overall score exceeds a given head-sides score threshold.

The head-top and head-side edge analyses are applied for all or part of the scene to identify those points that appear to resemble heads according to each analysis.

It will be clear to a person skilled in the art that the blurring filters 221, 231, can be selected as appropriate for the desired level of positional tolerance, which may, among other things, be a function of image resolution and/or relative object size if using a normalised input image. A typical pair of blurring filters may be

$$[ \begin{matrix}1 & 1 & 1 & 1 \\ 2 & 2 & 2 & 2 \\ 1 & 1 & 1 & 1\end{matrix} ] and [ \begin{matrix}1 & 2 & 1 \\ 1 & 2 & 1 \\ 1 & 2 & 1 \\ 1 & 2 & 1\end{matrix} ]$$

for horizontal and vertical blurring respectively.

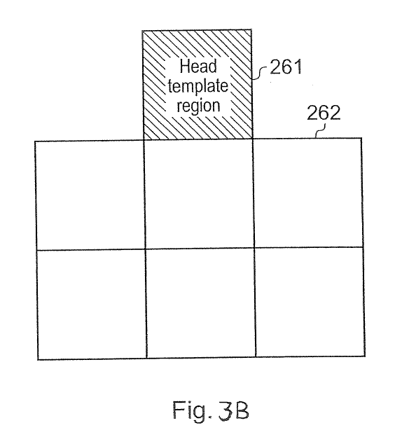

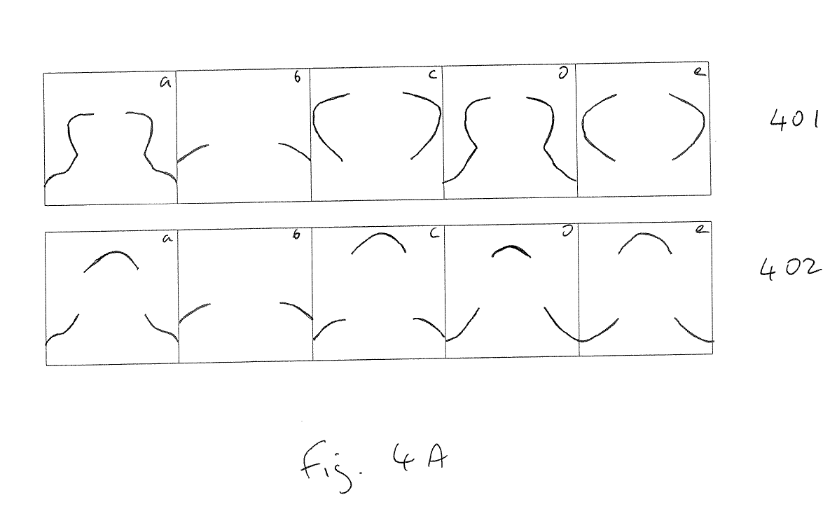

In FIG. 3A, in an embodiment of the present invention the edge magnitude map 240 is correlated with an edge template 246 for the centre of the head at each position on the map.

The correlation with the head-centre edge template ‘scores’ positively in a region central to the head area. A typical value is +1. Edges elsewhere in the template are not scored. Three possible outcomes are considered: if the overall score at a position on the map is too small, then it is assumed there are no facial features present and that the template is not centred over a head in the image. If the overall score at the position is too high, then the features are unlikely to represent a face and consequently the template is again not centred over a head in the image. Thus faces are signalled to be present if the overall score falls between given upper and lower face thresholds.

The head-centre edge template is applied over all or part of the edge magnitude map 240 to identify those corresponding points in the scene that appear to resemble faces according to the analysis.

It will be apparent to a person skilled in the art that facial detection will not always be applicable (for example in the case of factory lines, or where a proportion of people are likely to be facing away from the imaging means, or the camera angle is too high). In this case, the lower threshold may be suspended, allowing the detector to merely discriminate against anomalies in the mid-region of the template. Alternatively, head-centre edge analysis may not be used at all.

Referring now also to FIG. 3B, in an embodiment of the present invention, for each position on the V-map 230, a region 262 lying below the current notional position of the head templates 261 as described previously is analysed. This region is typically equivalent in width to three head templates, and in height to two head templates. The sum of vertical edge values within this region provides a body score, being indicative of the likely presence of a torso, arms, and/or a suit, blouse, tie or other clothing, all of which typically have strong vertical edges and lie in this region. A body is defined to be present if the overall body score exceeds a given body threshold.

This body region analysis step 160 is applied over all or part of the scene to identify those points that appear to resemble bodies according to the analysis, in conjunction with any one of the previous head or face analyses.

Again, it will be apparent to a person skilled in the art that such an analysis will not always be applicable. Alternatively, it may be clear to a person skilled in the art that the summation of other edges, horizontal or vertical, in a selected region relative to the other templates may be desirable instead of or as well as this measure, depending on the features of the individuals.

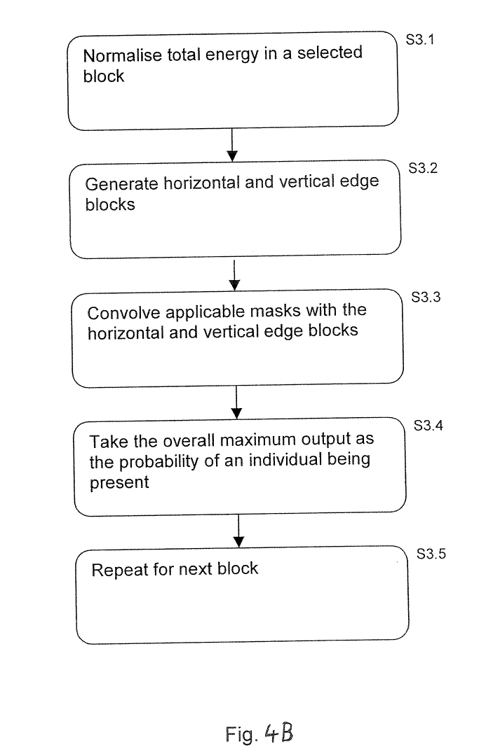

Referring now to FIG. 4A, in an alternative embodiment of the present invention, the head-top, head side and, if used, the body region analysis may be replaced by analysis using vertical and horizontal edge masks. The masks are based upon numerous training images of, for example, human heads and shoulders to which vertical and horizontal edge filtering have been separately applied as disclosed previously. Archetypal masks for various poses, such as side on or front facing are generated, for example by averaging many size-normalised edge masks. Typically there will be fewer than ten pairs of horizontal and vertical archetypal masks, thereby reducing computational complexity.

In FIG. 4, typical centre lines illustrating the positions of the positive values of the vertical edge masks 401(a-e) and the horizontal edge masks 402(a-e) are shown for clarity. In general, the edge masks will be blurred about these centre lines by the process of generation, such as averaging.

Referring now also to FIG. 4B, in such an embodiment individuals are detected during operation by applying edge mask matching analysis to blocks of the input image. These blocks are typically square blocks of pixels of a size typically encompassing the head and shoulders (or other determining feature of an individual) in the input image. The analysis then comprises the steps of:

normalising (s3.1) a selected block according to the total energy (brightness) present in the block;

generating (s3.2) horizontal and vertical edge blocks from the normalised block using horizontal and vertical edge filters;

convolving (s3.3) each of the archetypal masks with the horizontal or vertical edge block as appropriate;

taking (s3.4) the maximum output value from these convolutions to be the probability of an individual being centred at the position of the block in the input image; and

sampling (s3.5) blocks over the whole input image to generate a probability map indicating the possible locations of individuals in the image.

Thus far, the following analyses have been presented, without loss of generalisation, in relation to the detection of humans:
i. Detection of the top of a head by matching a blurred H-map to a horizontal template;
ii. Detection of the sides of a head by matching a blurred V-map to a vertical template; and
iii. Detection of a body by evaluating verticals in a region located with respect to the above templates, or
iv. Detection of a head by use of edge mask matching analysis; and
v. Detection of edge features in the centre of a template.

However, a person skilled in the art will appreciate that there are circumstances where any or all of these analyses, either singly or in combination, could be insufficient to discriminate individual people from other features.

For example, an empty public space decorated (as is often the case) with floor tiles or paving could apparently score very well using the above analyses and suggest that a large crowd of people is present when in fact there is none at all.

Thus, an additional analysis is desirable that can discriminate more closely a characteristic feature of the individual; for example, the shape of a head.

In the case of a human head, its roundedness, coupled with the presence of a body beneath, could be considered characteristic. For livestock, it could be the presence of a horned head, and for a bottle on a production line, the shape of its neck. Characteristic features for other individuals will be apparent to a person skilled in the art.

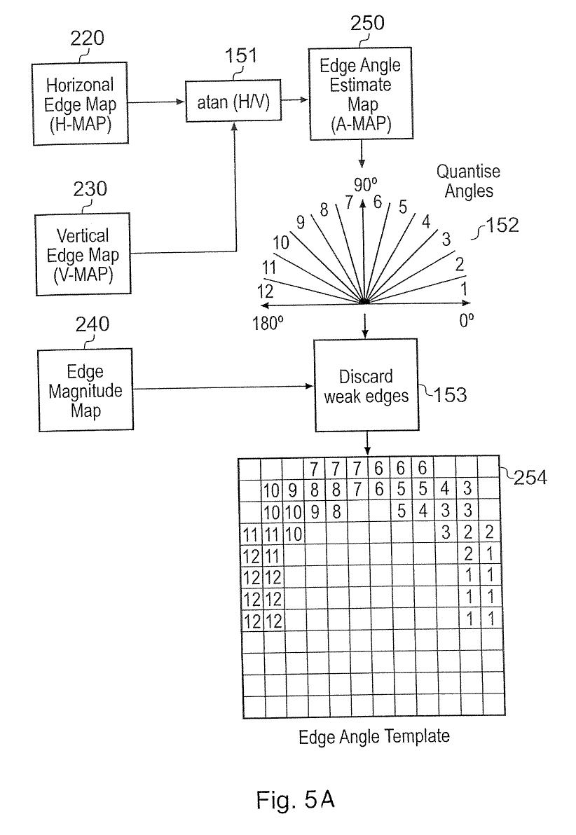

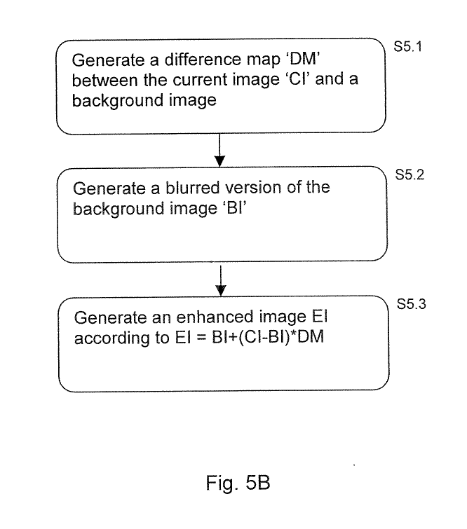

Referring now to FIG. 5, for an embodiment of the present invention, an edge angle analysis is performed.

When applying a spatial gradient operator such as the Sobel operator to the original image, the strength of vertical or horizontal edge generated is a function of how close to the vertical or horizontal the edge is within the image. Thus, a perfectly horizontal edge will have a maximal score using the horizontal operator and a zero score using the vertical operator, whilst a vertical edge will perform vice versa. Meanwhile, an edge angled at 45° or 135° will have a lower, but equal size, score from both operators. Thus information about the angle of the original edge is implicit within the combination of the H-map and V-map values for a given point.

An edge angle estimate map or A-map 250 can thus be constructed by applying at step 151

$${A}_{i , j} = arctan [ \frac{{H}_{i , j}}{{V}_{i , j}} ]$$

for each point i, j on the H-map 220 and V-map 230, to generate edge angle estimates normal to the edges. To simplify comparison and to reduce variability between successive points in the A-map, the estimated angle values of the A-map may be quantised at a step 152. The level of quantisation is a trade-off between angular resolution and uniformity for comparison. Notably, the quantisation steps need not be linear, so for example where a certain range of angles may be critical to the determination of a characteristic of an individual, the quantisation steps may be much finer than elsewhere. In an embodiment of the present invention, the angles in a 180° range are quantised equally into twelve bins, 1. . . 12. Alternatively, arctan(V/H) can be used, to generate angles parallel to the edges. In this case the angles can be quantised in a similar fashion.

Before or after quantisation, values from the edge magnitude map 240 are used in conjunction with a threshold to discard at a step 153 those weak edges not reaching the threshold value, from corresponding positions on the A-map 250. This removes spurious angle values that can occur at points where a very small V-map value is divided by a similarly small H-map value to give an apparently normal angular value.

Each point on the resulting A-map 250 or part thereof is then compared with an edge angle template 254. The edge angle template 254 contains expected angles (in the form of quantised values, if quantisation was used) at expected positions relative to each other on the template. In FIG. 5, an example edge angle template 254 is shown for part of a human head, such as might stand out from the body of an individual when viewed from a high vantage point typical of a CCTV. Alternative templates for different characteristics of individuals will be apparent to a person skilled in the art.

Difference values are then calculated for the A-Map 250 and the edge angle template 254 with respect to a given point as follows:

Because, for example, 0° and 180° in bins 1 and 12 respectively are effectively identical in an image, the difference value is calculated in a circular fashion, such that the maximum difference possible (for 12 quantisation bins) is 6 inclusively, representing a difference of 90° between any two angular values (for example, between bins 9 and 3, 7 and 1 or 12 and 6). Distance values decrease the further the bins are from 90° separation. Thus the difference score decreases with greater comparative parallelism between any two angular values.

The smallest difference score in each of a plurality of local regions is then selected as showing the greatest positional and angular correspondence with the edge angle template 254 in that region. The local regions may, for example, be each column corresponding with the template, or groups approximating arcuate segments of the template, or in groups corresponding to areas with the same quantised bin value in the template.

This allows for some position and shape variability for heads in the observed image. Position and shape variability may be a function of, among other things, image resolution and/or relative object size if using a normalised input image, as well as a function of variation among individuals.

A person skilled in the art will also appreciate that tolerance of variability can be altered by the degree of quantisation, the proportion of the edge angle template populated with bins, and the difference value scheme used (for example, using a square of the difference would be less tolerant of variability).

The selected difference scores are then summed together to produce an overall angular difference score. A head is defined to be present if the difference score is below a given difference threshold.

Finally, in an embodiment of the present invention, the scores from each of the analyses described previously may be combined at a step 170 to determine if a given point from the image data represents all or part of the image of a head. The score from each analysis is indicative of the likelihood of the relevant feature being present, and is compared against one or more thresholds.

A positive combined result corresponds to satisfying the following conditions:
i. head-top score>head-top score threshold;
ii. head-sides score>head-sides score threshold;
iii. lower face threshold>head-centre likelihood score>upper face threshold;
iv. body score>body threshold, and;
v. angular difference score<angular difference threshold.

In conjunction with condition v., any or all of conditions i-iv may be used to decide if a given point in the scene represents all or part of a head.

Alternatively, in conjunction with condition v., the probability map generated by the edge mask matching analysis shown in FIG. 3C may be similarly thresholded such that the largest edge mask convolution value must exceed an edge mask convolution value threshold. The substantial coincidence of thresholded points from both the angular difference scope and edge match analysis is then taken at the combining step 170 to be indicative of an individual being present.

Once each point has been classified, each point (or group of points located within a region roughly corresponding in size to a head template) is considered to represent an individual. The number of points or groups of points can then be counted to estimate the population of individuals depicted in the scene.

In an alternative embodiment, the angular difference score, in conjunction with any or all of the other scores or schemes described above, if suitably weighted, can be used to give an overall score for each point in the scene. Those points with the highest overall scores, either singly or within a group of points, can be taken to best localise the positions of peoples heads (or any other characteristic being determined), subject to a minimum overall threshold. These points are then similarly counted to estimate the population of individuals in the scene.

In this latter embodiment, the head-centre score, if used, is a function of deviation from a value centred between the upper and lower face thresholds as described previously.

Referring now also to FIG. 5B, optionally the input image can be pre-processed to enhance the contrast of moving objects in the image so that when horizontal and vertical edge filters are applied, comparatively stronger edges are generated for these elements. This is of particular benefit when blocks comprising the edges of objects are subsequently normalised and applied to the edge mask matching analysis as described previously.

In a first step S5.1, a difference map between the current image and a stored image of the background (e.g. an empty scene) is generated. (Optionally, the background image is obtained by used of a long term average of the input images received).

In a second step S5.2 the background image is low pass filtered to create a blurred version, thus having reduced contrast.

In a third step S5.3, the current image ‘CI’, the blurred background image ‘BI’ and the difference map ‘DM’ are used to generate an enhanced image ‘EI’, according to the equation EI=BI+(CI−BI)*DM.

The resulting enhanced image thus has a reduced contrast in those sections of the image that resemble the background due to the blurring, and an enhanced contrast in those sections of the image that are difference, due to the multiplication by the difference map. Consequently the edges of those features new to the scene will be comparatively enhanced when the overall energy of the blocks is normalised.

It will be appreciated by a person skilled in the art that the difference map may be scaled and/or offset to produce an appropriate multiplier. For example, the function MAX(DM*0.5+0.4, 1) may be used.

Likewise, it will be appreciated that typically this method is applied for a single (luminance/greyscale) channel of an image only, but optionally could be performed for each of the RGB channels of an image.

For any of the above embodiments, once individuals have been identified within the input image, optionally a particle filter, such as that of M. S. Arulampalam et. al., noted previously, may be applied to the identified positions.

In an embodiment of the present invention, 100 particles are assigned to each track. Each particle represents a possible position of one individual, with the centroid of the particles (weighted by the probability value at each particle) predicting the actual position of the individual. An initialised track may be ‘active’ in tracking an individual, or may be ‘not active’ and in a probationary state to determine if the possible individual is, for example, a temporary false-positive. The probationary period is typically 6 consecutive frames, in which an individual should be consistently identified. Conversely, an active track is only stopped when there has been no identification of the individual for approximately 100 frames.

Each particle in the track has a position, a probability (based on the angular difference score and any of the other scores or schemes used) and a velocity based on the historic motion of the individual. For prediction, the position of a particle is updated according to the velocity.

The particle filter thus tracks individual positions across multiple input image frames. By doing so, the overall detection rate can be improved when, for example, a particular individual drops below the threshold value for detection, but lies on their predicted path. Thus the particle filter can provide a compensatory mechanism for the detection of known individuals over time. Conversely, false positives that occur for less than a few frames can be eliminated.

Tracking also provides additional information about the individual and about the group in a crowd situation. For example, it allows an estimate of how long an individual dwells in the scene, and the path they take. Taken together, the tracks of many individuals can also indicate congestion or panic according to how they move.

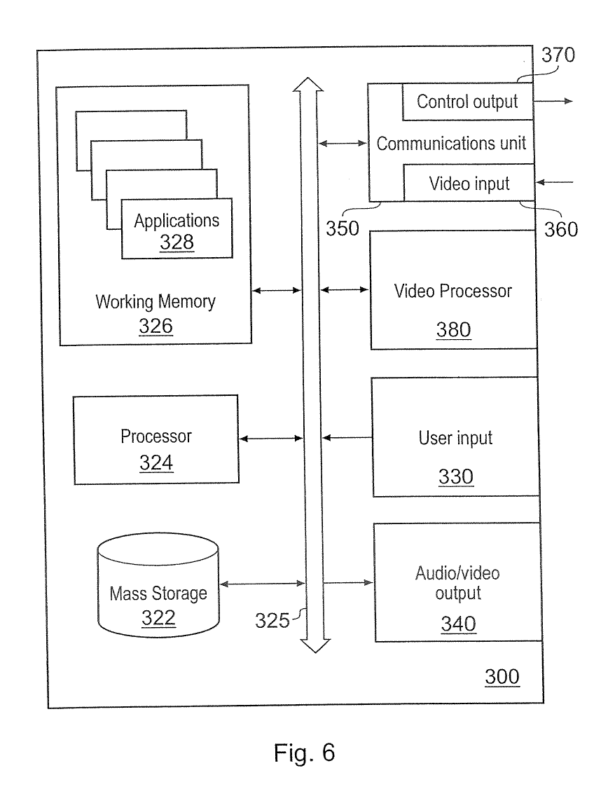

Referring now to FIG. 6, a data processing apparatus 300 in accordance with an embodiment of the present invention is schematically illustrated. The data processing apparatus 300 comprises a processor 324 operable to execute machine code instructions (software) stored in a working memory 326 and/or retrievable from a removable or fixed storage medium such mass storage device 322 and/or provided by a network or internet connection (not shown). By means of a general-purpose bus 325, user operable input devices 330 are in communication with the processor 324. The user operable input devices 330 comprise, in this example, a keyboard and a touchpad, but could include a mouse or other pointing device, a contact sensitive surface on a display unit of the device, a writing tablet, speech recognition means, haptic input means, or any other means by which a user input action can be interpreted and converted into data signals.

In the data processing apparatus 300, the working memory 326 stores user applications 328 which, when executed by the processor 324, cause the establishment of a user interface to enable communication of data to and from a user. The applications 328 thus establish general purpose or specific computer implemented utilities and facilities that might habitually be used by a user.

Audio/video output devices 340 are further connected to the general-purpose bus 325, for the output of information to a user. Audio/video output devices 340 include a visual display, but can also include any other device capable of presenting information to a user.

A communications unit 350 is connected to the general-purpose bus 325, and further connected to a video input 360 and a control output 370. By means of the communications unit 350 and the video input 360, the data processing apparatus 300 is capable of obtaining image data. By means of the communications unit 350 and the control output 370 the data processing apparatus 300 is capable of controlling another device enacting an automatic response, such as opening or closing a gate, or sounding an alarm.

A video processor 380 is also connected to the general-purpose bus 325. By means of the video processor, the data processing apparatus is capable of implementing in operation the method of estimating the number of individuals in a scene, as described previously.

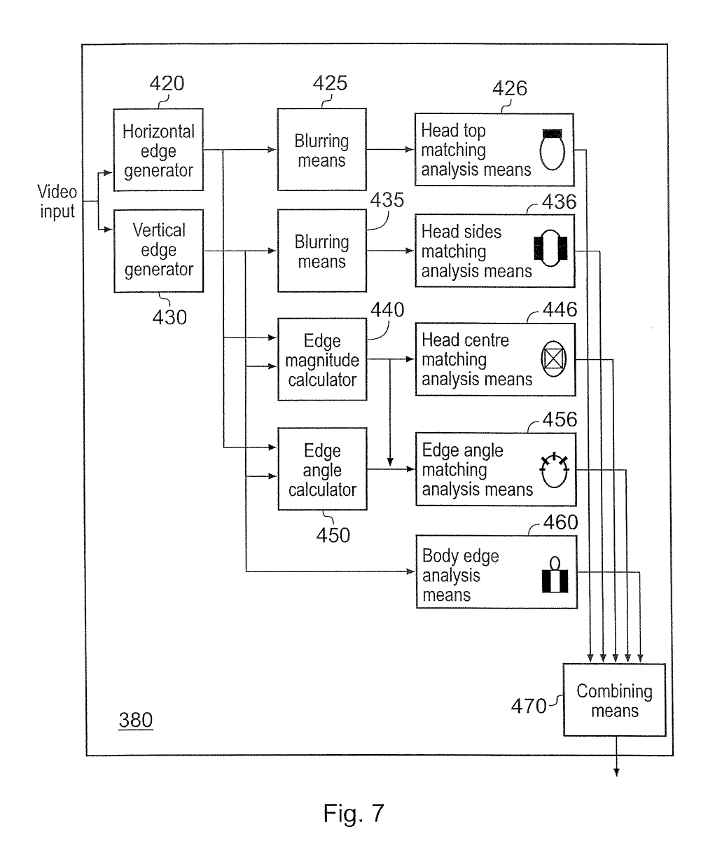

Referring now to FIG. 7, specifically the video processor 380 comprises horizontal and vertical edge generation means 420 and 430 respectively. The horizontal and vertical edge generation means 420 and 430 are operably coupled to each of:

an edge magnitude calculator 440, image blurring means (425, 435), and an edge angle calculator 450.

Outputs from these means are passed to analysis means within the video processor 380 as follows:

Output from the vertical edge generation means 430 is also passed to a body-edge analysis means 460;

Output from the image burring means (425, 435) is passed to a head-top matching analysis means 426 if using horizontal edges as input or a head-side matching analysis means 436 if using vertical edges as input.

Output from the edge magnitude calculator 440 is passed to a head-centre matching analysis means 446 and to an edge angle matching analysis means 456.

Output from the edge angle calculator 450 is also passed to the edge angle matching analysis means 456.

Outputs from the above analysis means (426, 436, 446, 456 and 460) are then passed to combining means 470, arranged in operation to determine if the combined analyses of analysis means (426, 436, 446, 456 and 460) indicate the presence of individuals, and to count the number of individuals thus indicated.

The processor 324 may then, under instruction from one or more applications 328, either alert a user via audio/visual output means 330, and/or instigate an automatic response via control output 370. This may occur if the number of individuals, for example, exceeds a safe threshold, or comparisons between successive analysed images suggests there is congestion (either because indicated individuals are not moving enough, or because there is low variation in the number of individuals counted).

It will be apparent to a person skilled in the art that any or all of blurring means (425, 435), head-top matching analysis means 426, head-side matching analysis means 436, head- centre matching analysis means 446 and a body-edge analysis means 460 may not be appropriate for every situation. In such circumstances any or all of these may either be bypassed, for example by combining means 470, or omitted from the video processor means 380.

A person skilled in the art will similarly appreciate that the user input 330, audio/video output 340 and control output 370 as described above may not be appropriate for every situation. For example, the user input may instead simply comprise an on/off switch, and the audio/video output may simply comprise a status indicator. Furthermore, if automatic control is not required in response to the number of individuals counted, then control output 370 may be omitted.

It will also be appreciated that in embodiments of the present invention, the video processor and the various elements it comprises may be located either within the data processing apparatus 300, or within the video processor 380, or distributed between the two, in any suitable manner. For example, video processor 380 may take the form of a removable PCMCIA or PCI card. In a converse example, the communication unit 350 may hold a proportion of the elements described in relation to the video processor 380, for example the horizontal and vertical edge generation means 420 and 430.

Thus the present invention may be implemented in any suitable manner to provide suitable apparatus or operation. In particular, it may consist of a single discrete entity, a single discrete entity such as a PCMCIA card added to a conventional host device such as a general purpose computer, multiple entities added to a conventional host device, or may be formed by adapting existing parts of a conventional host device, such as by software reconfiguration, e.g. of applications 328 in working memory 326. Alternatively, a combination of additional and adapted entities may be envisaged. For example, edge generation, magnitude calculation and angle calculation could be performed by the video processor 380, whilst analyses are performed by the central processor 324 under instruction from one or more applications 328. Alternatively, the central processor 324 under instruction from one or more applications 328 could perform all the functions of the video processor. Thus adapting existing parts of a conventional host device may comprise for example reprogramming of one or more processors therein. As such the required adaptation may be implemented in the form of a computer program product comprising processor-implementable instructions stored on a data carrier such as a floppy disk, hard disk, PROM, RAM or any combination of these or other storage media, or transmitted via data signals on a network such as an Ethernet, a wireless network, the internet, or any combination of these or other networks.

It will further be appreciated by a person skilled in the art that references herein to each point in an image is subject to boundaries imposed by the size of various transforming operators and templates, and moreover if appropriate may be further bound by a user to exclude regions of a fixed view that are irrelevant to analysis, such as the centre of a table, or the upper part of a wall. In addition it will similarly be appreciated that a point may be a pixel or a nominated test position or region within an image and may if appropriate be obtained by any appropriate manipulation of the image data.

A person skilled in the art will also appreciate that more than one edge angle template 254 may be employed in the analysis of a scene, for example to discriminate people with and without hats, or full and empty bottles, or mixed livestock.

Finally, a person skilled in the art will appreciate that embodiments of the present invention may confer some or all of the following advantages;
i. an edge matching method is provided that has comparatively low computational requirements;
ii. the method is able to discriminate an arbitrary profile characteristic particular to a type of individual, by virtue of edge angle analysis;
iii. an individual may be mobile or stationary;
iv. individuals can overlap in the scene;
v. other elements of the scene can be discounted by reference to the profile characteristic particular to the type of individual;
vi. the method is not limited to human characteristics such as locomotion, but is applicable to a plurality of types of individuals;
vii. however, the method is further able to discriminate individuals by virtue of body, head and face analyses as appropriate, and;
viii. the method facilitates alerting or automatically responding to indications of overcrowding and/or congestion in the analysed scene.

Although illustrative embodiments of the invention have been described in detail herein with respect to the accompanying drawings, it is to be understood that the invention is not limited to those precise embodiments, and that various changes and modifications can be effected therein by one skilled in the art without departing from the scope and spirit of the invention as defined by the appended claims.

We claim:

1. A method of estimating the number of individuals in an image, the method comprising the steps of:
(i) generating, for a plurality of image positions within at least a portion of a captured image of the scene, an edge correspondence value indicative of positional and angular correspondence with a template representation of at least a partial outline of an individual, and;
(ii) detecting whether image content at each of the image positions corresponds to at least a part of an image of an individual in response to said detected edge correspondence value.

2. A method according to claim 1, in which said step of generating the edge correspondence value comprises:
comparing, for an image position in said image, a plurality of edges derived from said captured image with at least a first edge angle template located with respect to that image position, said edge angle template relating expected edge angles to expected relative positions between said edges, the expected relative positions between said edges being representative of at least said partial outline of said individual.

3. A method according to claim 1, in which an edge angle template relating expected edge angles to expected relative positions between said edges comprises a spatial distribution of angular values over said edge angle template, such that said angular values are located with respect to positions representative of at least said partial outline of said individual where such corresponding angles are likely to be present.

4. A method according to claim 1, wherein said at least partial outline of said individual is an at least partial outline of a head.

5. A method according to claim 1, comprising the step of:
obtaining horizontal edge values and vertical edge values by respective application of a horizontal and a vertical spatial gradient operator to said portion of said captured image.

6. A method according to claim 1, comprising the step of:
further processing said horizontal edge values and vertical edge values in combination to generate edge magnitude values.

7. A method according to claim 1, comprising the step of:
obtaining edge angle estimates by analysis of corresponding vertical and horizontal edge values.

8. A method according to claim 7, comprising the step of:
obtaining edge angle estimates by applying an arctan function to a quotient of corresponding vertical and horizontal edge values.

9. A method according to claim 7, comprising the step of:
discarding edge angle estimates corresponding to low-magnitude edge values.

10. A method according to claim 7, comprising the step of:
evaluating edge angle estimates against an edge angle template as a function of the relative parallelism found between an edge angle estimate and said edge angle value located at a corresponding position on said template.

11. A method according to claim 10, comprising the steps of:
evaluating, within each of a plurality of zones of said edge angle template, said edge angle estimate most parallel to an edge angle value at the corresponding position on said edge angle template, and;
combining the differences in angular value between each such selected edge angle estimate and said corresponding edge angle template value for said plurality of zones to generate the edge correspondence value indicative of overall positional and angular correspondence with said edge angle template.

12. A method according to claim 7, comprising the step of:
quantising edge angle estimates and edge angle template values.

13. A method according to claim 1, in which said step of defining whether each of said plurality of image positions contributes to at least part of an image of said individual further comprises the step of satisfying one or more conditions selected from the list consisting of:
i. a body likelihood value exceeds a body value threshold;
ii. a head-centre likelihood value lies within the bounds of an upper and a lower head centre threshold;
iii. a head-top likelihood value exceeds a head-top value threshold;
iv. a head-sides likelihood value exceeds a head-sides value threshold; and
v. an edge mask convolution value exceeds an edge mask convolution value threshold.

14. A method according to claim 13, comprising the step of:
generating a body likelihood value for an image position in said scene by the summation of vertical edge values occurring in a region centred below that image position.

15. A method according to claim 13, comprising the step of:
generating a head-centre likelihood value for an image position in said scene by correlating edge magnitudes with a head-centre template positioned with respect to that image position, said head-centre template scoring positively in a central region of said head-centre template only.

16. A method according to claim 13, comprising the step of:
blurring horizontal edges and vertical edges to generate values adjacent to said edges, said values diminishing with distance from to said edges.

17. A method according to claim 16, comprising the step of:
generating a head-top likelihood value for an image position in said scene by correlating blurred horizontal edges with a head-top template positioned with respect to that image position, said template scoring positively in an upper region of said head-top template only, and negatively in a central region of said head-top template only.

18. A method according to claim 16, comprising the step of:
generating a head-sides likelihood value for a point in said scene by correlating blurred vertical edges with a head-sides template positioned with respect to that image position, said template scoring positively in side regions of said head-sides template only, and negatively in a central region of said head-sides template only.

19. A method according to claim 13, comprising the step of:
generating an edge mask convolution value for a point in said scene by convolving normalised horizontal and vertical edges with one or more respective horizontal and vertical edge masks, and selecting the largest output value as said edge mask convolution value.

20. A method according to claim 1, in which said captured image is first enhanced by the steps of:
generating a difference map between said captured image and a background image;
applying a low-pass filter to said background image to create a blurred background image; and
subtracting said blurred background image from said captured image, multiplying the result based upon said difference map values, and adding the output of said multiplication to said blurred background image.

21. A method according to claim 1, comprising the step of:
estimating the number of individuals in an image by counting those image positions, or localised groups of image positions, detected to be contributing to at least part of an image of an individual.

22. A method according to claim 21 comprising the step of:
estimating a change in said number of individuals in said image by comparing successive estimates of said number of individuals in respective successive images.

23. A data processing apparatus, arranged in operation to estimate said number of individuals in a scene, said apparatus comprising;
an analyser operable to generate, for a plurality of image positions within at least a portion of a captured image of said scene, an edge correspondence value indicative of positional and angular correspondence with a template representation of at least a partial outline of an individual, and
logic operable to detect whether image content at each of said image positions corresponds to at least a part of an image of an individual in response to said detected edge correspondence value.

24. A data processing apparatus according to claim 23, comprising an edge angle matcher arranged in operation to compare a plurality of edges derived from said image data with at least a first edge angle template located with respect to that image position, said edge angle template relating expected edge angles to expected relative positions between said edges, said expected relative positions between said edges being representative of at least said partial outline of said individual, and said edge angle matcher outputting said edge correspondence value based upon said comparison.

25. A data processing apparatus according to claim 23, further comprising an edge angle calculator operable to apply an arctan function to a quotient of corresponding horizontal and vertical edge values.

26. A data processing apparatus according to claim 23, in which said edge angle matcher is arranged in operation to evaluate edge angle estimates against an edge angle template as a function of the relative parallelism found between an edge angle estimate and said edge angle value located at a corresponding position on said template.

27. A data processing apparatus according to claim 23, in which said edge angle matcher is arranged in operation to select, within a plurality of zones of said edge angle template, said edge angle estimate evaluated as most parallel to an edge angle value at the corresponding position on said edge angle template, and combine the differences between the most parallel edge angle estimate and said edge angle value at the corresponding position for said plurality of zones to generate said edge correspondence value, being indicative of overall positional and angular correspondence with said edge angle template.

28. A data carrier comprising computer readable instructions that, when loaded into a computer, cause said computer to carry out the method of claim 1.

29. A data carrier comprising computer readable instructions that, when loaded into a computer, cause said computer to operate as a data processing apparatus according to claim 23.

30. A data signal comprising computer readable instructions that, when received by a computer, cause said computer to carry out the method of claim 1.

31. A data signal comprising computer readable instructions that, when received by a computer, cause said computer to operate as a data processing apparatus according to claim 23.

32. Computer readable instructions that, when received by a computer, cause said computer to carry out the method of claim 1.

33. Computer readable instructions that, when received by a computer, cause said computer to operate as a data processing apparatus according to claim 23.
